(19) United States
(12) Patent Application Publication
(10) Pub. No.: US 2018/0061162 A1
(43) Pub. Date: Mar. 1, 2018

(54) SMART PACKAGE

(71) Applicant: Wal-Mart Stores, Inc., Bentonville, AR (US)

(72) Inventors: Donald R. High, Noel, MO (US); Chandrashekar Natarajan, Valencia, CA (US); John J. O'Brien, V, Farmington, AR (US); Robert Cantrell, Herndon, VA (US); Todd Mattingly, Bentonville, AR (US); Brian Gerard McHale, Oldham (GB); Bruce Walter Wilkinson, Rogers, AR (US)

(21) Appl. No.: 15/684,991

(22) Filed: Aug. 24, 2017

Related U.S. Application Data
(60) Provisional application No. 62/381,235, filed on Aug. 30, 2016.

(51) Int. Cl. G07C 9/00; G06Q 10/08

(52) U.S. Cl. CPC G07C 9/00817; G07C 2009/0092; G07C 9/00309; G06Q 10/083

(57) ABSTRACT

Provided is a smart package. The smart package may include a body portion having an inner volume. A door may be coupled to the body portion, wherein the door is moveable between a closed and an open position. In the closed position the door restricts access to the inner volume of the body portion. In the open position, an opening to the inner volume is exposed for access to the inner volume. The smart package may also include a monitoring device, wherein the monitoring device controls and monitors operation of the smart package, such as monitoring the status of the contents and the environment of the inner volume of the smart package. The smart package may also include a modular adapter coupled to an outer surface of the body portion, wherein the modular adapter is configured to releasably connect to an output of a delivery vehicle system.

### CROSS REFERENCE TO RELATED APPLICATION[S]

This application claims priority to U.S. Provisional Patent Application entitled “SMART PACKAGE,” Ser. No. 62/381,235, filed Aug. 30, 2016, the disclosure of which are hereby incorporated entirely herein by reference.

### FIELD OF THE INVENTION

The invention relates generally to a package for shipping goods, and more specifically, to smart package for shipping goods.

### BACKGROUND

Managing a packages environment when it goes from distribution or fulfillment center to the customer's home has been a challenge. Various solutions have been proposed and each of those solutions is lacking. With the emergence of autonomous vehicles serving as couriers for packages, a possible solution for cold chain management and the environment of a package exists. Additionally, the Internet of things is being incorporated into many packaging solutions. However, the existing solutions sill lack the ability to track our packages at all times, including knowing who has custody of the package, what is in the package, why the package is in the state that it is in, where the package is located, and when the package will be delivered, companies would be able to more intelligently eliminate shrink with packages in the delivery cycle.

### BRIEF SUMMARY

In one aspect, provided is a smart package comprising: a body portion having an inner volume; a door coupled to the body portion, wherein the door is moveable between a closed and an open position, wherein in the closed position the door restricts access to the inner volume of the body portion and in the open position, an opening to the inner volume is exposed for access to the inner volume; and a modular adapter coupled to an outer surface of the body portion, wherein the modular adapter is configured to releasably connect to an output of a delivery vehicle system.

In another aspect, provided is a smart package comprising: a body portion having an inner volume; a door coupled to the body portion, wherein the door is moveable between a closed and an open position, wherein in the closed position the door restricts access to the inner volume of the body portion and in the open position, an opening to the inner volume is exposed for access to the inner volume; a monitoring device, wherein the monitoring device controls and monitors operation of the smart package; and a modular adapter coupled to an outer surface of the body portion, wherein the modular adapter is configured to releasably connect to an output of a delivery vehicle system.

In another aspect, provided is a method of using a smart package, the method comprising: placing a payload within an inner volume of a body portion of the smart package; coupling a modular adapter to an output of a delivery vehicle system; monitoring operation of the smart package; communicating information regarding operation of the smart package with the delivery vehicle system; and automatically adjusting the output of the delivery vehicle system in response to the delivery vehicle system processing the communicated information.

In another aspect, provided is a smart package comprising: a body portion having an inner volume; a door coupled to the body portion, wherein the door is moveable between a closed and an open position, wherein in the closed position the door restricts access to the inner volume of the body portion and in the open position, an opening to the inner volume is exposed for access to the inner volume; a modular adapter coupled to an outer surface of the body portion, wherein the modular adapter is configured to releasably connect to an output of a delivery vehicle system; and a delivery encryption system comprising a block chain for package tracking and authentication.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a front perspective view of a smart package in accordance with an embodiment.

FIG. 2 is a rear perspective view of a smart package in accordance with an embodiment.

FIG. 3 is a perspective view showing smart package with contents within an inner volume in accordance with an embodiment.

FIG. 4 is a block diagram of a smart package coupled within a vehicle for delivery in accordance with an embodiment.

FIG. 5 is a flow diagram illustrating a method for using a smart package, in accordance with some embodiments.

FIG. 6 is a flow diagram of a delivery encryption system using a block chain, in accordance with some embodiments.

FIG. 7 is a flow diagram of a block chain for use with a smart package, in accordance with some embodiments.

FIG. 8 is another flow diagram of forming a block chain for use with a smart package, in accordance with some embodiments.

### DETAILED DESCRIPTION

Many customers shop online for various reasons include ease of shopping, comfort of shopping, to save time and any number of other reasons that customers may have for shopping online. These online customers many times seek to purchase items that may require a controlled environment and further seek to have greater security in the shipping packaging that the items are shipped in. Current shipping packaging does not provide for such desired functionality.

The present inventive concepts include a smart package that has the ability to control the environment of an inner volume of the smart package, to monitor the status of the contents and item within the smart package, and provide secured access to the contents of the smart package. For example, and without limitation, the smart package may allow the package to provide environment control for the contents therein; may for tracking of the products inside; may require user-authentication to engage with the contents of the smart package; and may have modular adapters on its surfaces to allow for battery replenishment and environment control inputs through delivery vehicle systems. The smart package may include an onboard computer system contained that is programmed to communicate the status of the contents inside the smart package as well as its contents with the delivery vehicle. Further, the delivery vehicle will deploy environment control agents and power to the smart package in an effort to protect the contents inside. The onboard computer system of the smart package may also track packages as they are removed or inserted into smart package's payload or inner volume. This information may be transmitted to the retailer's delivery ecosystem.

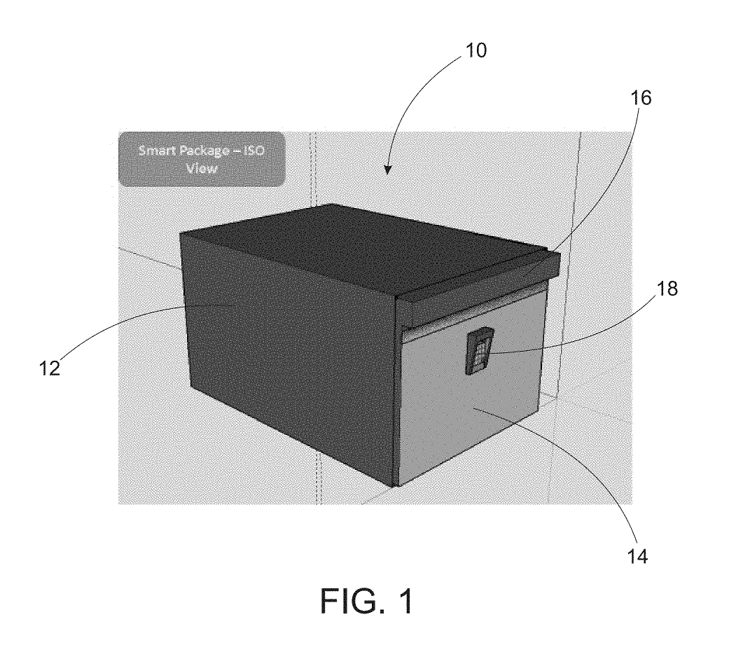

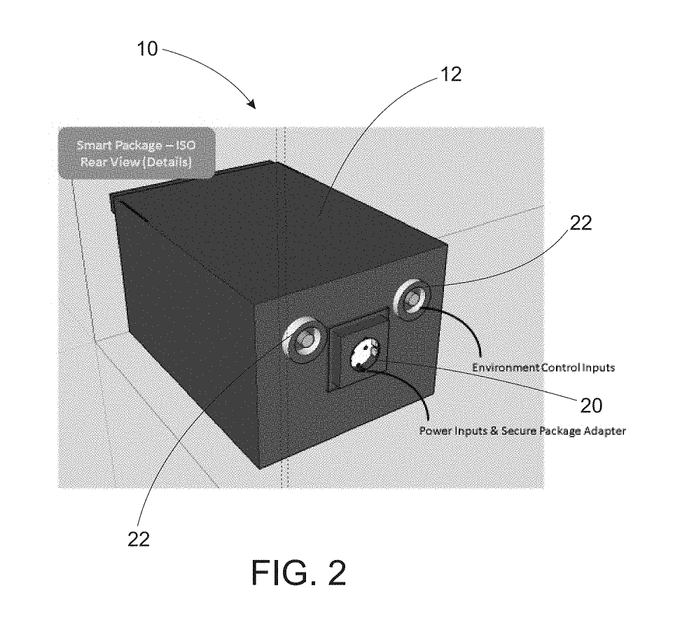

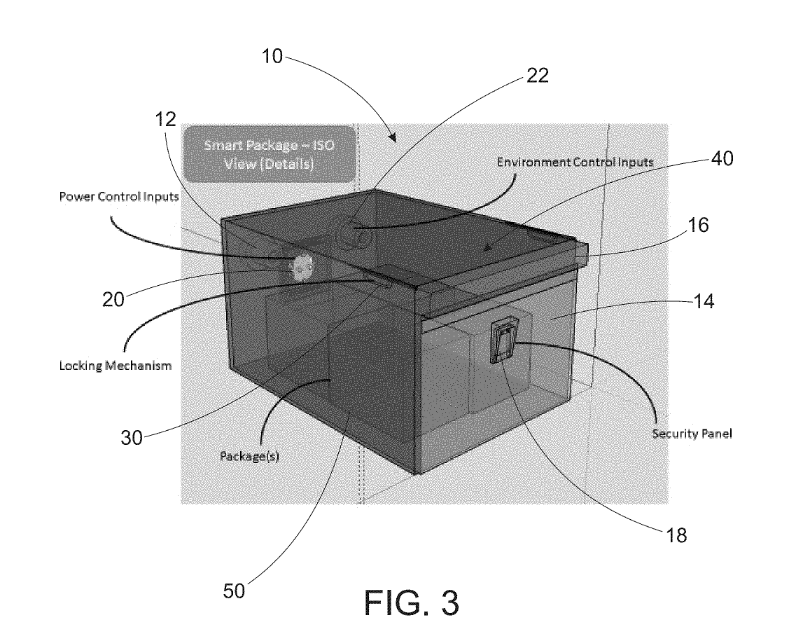

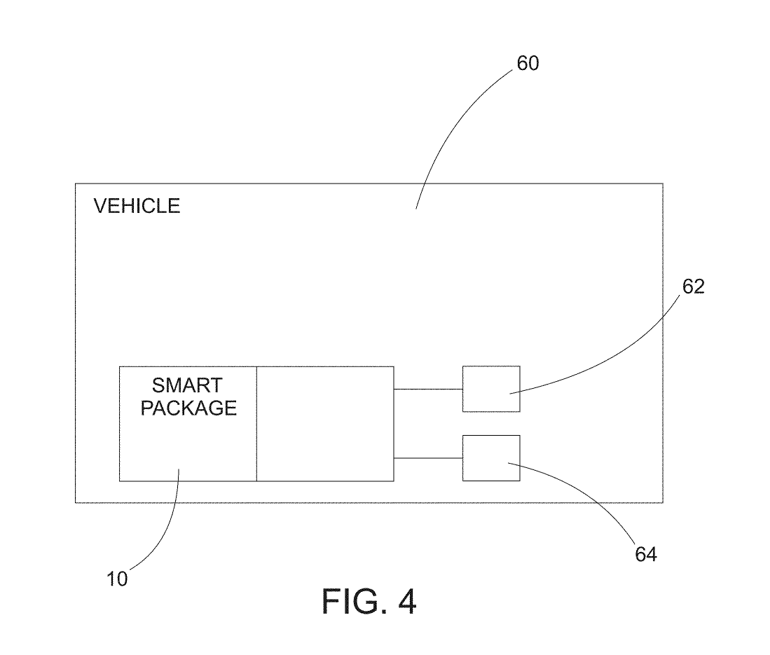

FIGS. 1-4 depict a smart package 10 according to embodiments of the present invention. The smart package 10 may include a body portion 12 having an inner volume 40. The smart package 10 further includes a door 14 coupled to the body portion 12. The door is moveable between a closed and an open position. In the closed position, the door restricts access to the inner volume 40 of the body portion 12. In the open position, an opening to the inner volume 40 is exposed for access to the inner volume 40. The smart package 10 further includes a modular adapter 20, 22 coupled to an outer surface of the body portion 12. The modular adapter 20, 22 is configured to releasably connect to an output 62 or 64 of a delivery vehicle 60 system.

In embodiments, the modular adapter 20, 22 may be multiple types of adapters, such as, but not limited to power input and secure package adapter 20, environmental adapter 22, and the like. The following examples are provided for the exemplary purposes of this disclosure and not as a limitation: the modular adapter 22 that is an environmental adapter may be coupled to an air conditioning unit output of the delivery vehicle system; the modular adapter 22 that is an environmental adapter may be coupled to a temperature regulator output of the delivery vehicle system; the modular adapter 22 that is an environmental adapter may be a humidity regulator output of the delivery vehicle system; the modular adapter 20 that is a power input may be coupled to a power source output of the delivery vehicle system; the modular adapter 20 that is a secure package adapter may be coupled to a security panel output of the delivery vehicle system; and combinations thereof. In some embodiments, the modular adapter 20, 22 includes at least two modular adapters 20, 22. When at least two modular adapters are included with the smart package 10, it may include one of the adapters 20 or 22 as described above wherein each adapter is coupled to one of an air conditioning unit output, a temperature regulator output, a humidity regulator output, a power source output and a security panel output of the delivery vehicle system, wherein each modular adapter is coupled to a different output of the delivery vehicle system.

The smart package 10 may include a monitoring device 18. The monitoring device 18 controls and monitors operation of the smart package 10. The monitoring device 18 monitors environmental conditions and status of contents 50 within the body portion 12 of the smart package 10. The monitoring device 18 may monitor and control a power source of the smart package 10. The monitoring device 18 may monitor a location of the smart package 10. The monitoring device 18 may control access to the inner volume 40 of the body portion 12 and operate as a security panel. The monitoring device 18 monitors content 50 insertion and content removal into and out of the inner volume 40 of the body portion 12 through use and connection to a package reader 16.

Further, the monitoring device 18 monitors connection and disconnection of the smart package 10 modular adapter 20, 22 with an output of the delivery vehicle system. In these embodiments, the monitoring device 18 is communicatively coupled to the delivery vehicle system and a central computing system and communicates information determined from the monitoring device 18 regarding the smart package 10 and the contents 50 therein. The delivery vehicle system may adjust outputs in response to processing the information communicated from the monitoring device 18.

During use, when an item 50 is placed into the smart package 10, the smart package 10 will monitor, track, and control item(s) 20, as well as the environment of the inner volume. The tracking can be accomplished by use of the monitoring device 18 that may include an onboard computer that receives input from RFID, video analytics, barcode scanning, and the like.

Further, the smart package may monitor the status of the contents or items 50. For example and without limitation, the smart package 10 will track information regarding the presence or removal of an item when the item is placed in the inner volume 40 or payload of the smart package 10. The smart package 10 may monitor the environmental conditions of the inner volume 40. The smart package 10 may monitor the environmental conditions of contents 50 placed in the inner volume 40. The smart package 10 may be able to monitor items 50 that may include perishable goods, such as cold chain products, and be able to deploy environmental agents for sustainability of the product 50.

Further, in use, the smart package 10 may communicate the status of contents 50 as well as the environment of the inner volume 40 by use of the monitoring device 18. For example and without limitation, this communication may send information from the smart package 10 to a Central Computer System, which may communicate messages regarding location, temperature, humidity, package status, delivery status, security panel access, removal or insertion of products, and the like; or this communication may send information from the smart package 10 to an Autonomous Vehicle System or a Traditional Delivery System of the status of the smart package 10, and when necessary, the smart package 10 may communicate information on the necessity of environmental control agents that the vehicle system, whether autonomous or traditional, may deploy necessary environmental control agents, such as air conditioning in response to such communication.

Also in use, the smart package 10 may connect to a delivery vehicle 60, such as an autonomous vehicle by connecting to the autonomous vehicle systems or other delivery vehicle systems. The modular adapter 20 or 22 may provide, for example and without limitation, connections to allow for environment control agents to be deployed into the inner volume 40, connections to allow for transference of power from the vehicle system to smart package 10 that may power the smart package 10 directly or charge an onboard battery of the smart package 10, and/or supply power to computer systems, security panels, etc.; connections to autonomous vehicle systems or other delivery vehicle systems including but are not limited to air conditioner units, temperature regulators, humidity regulators, power transference, security panels, and the like; and connections to allow for autonomous vehicle systems to securely move the smart package 10 (such as smart package adapter 20), which may eliminate the risk of a smart package 10 being lost during flight or ground transportation. This smart package adapter 20 may allow for seamless connection and disconnection from vehicle systems, wherein the connection between the vehicle system and the smart package 10 may be tracked; and the connection between the delivery vehicle system may be monitored for connective security.

In embodiments, the smart package 10 may feature a security panel on its surface, such as monitoring device 18. This security panel 18 allows a user to engage the smart package 10 and access the inner volume 40 once the user has been approved through its user authentication. Interaction and use of the security panel 18 may transmit data to a Central Computer System (“CCS”). For example, if a customer has accessed the security panel 18 and removed an item 50 from within the smart package 10, this information will be communicated with the CCS. If a thief has attempted to access the packages through the panel, the denial of service will be transmitted to the CCS. In these embodiments, user authentication and security access may require, but is not limited to the following authentication systems: i) fingerprint; ii) voice prints/voice signatures; iii) IRIS scans; iv) Personal Physical Signals, such as: Unique Heart rate information, DNA; v) Natural Body Identification—RFID implants, brain implants, silicon chips, digestible chips, ingestible chips powered by stomach acids; vi) Video analytics; vii) Unique code sent to a smart device; and viii) Multifactor authentication: a combination of multiple security access mediums, such as any of the above in combination.

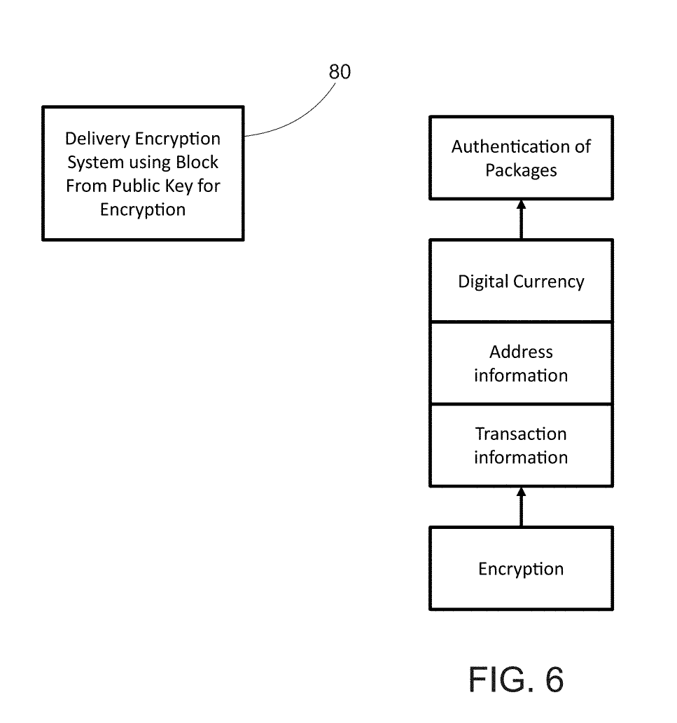

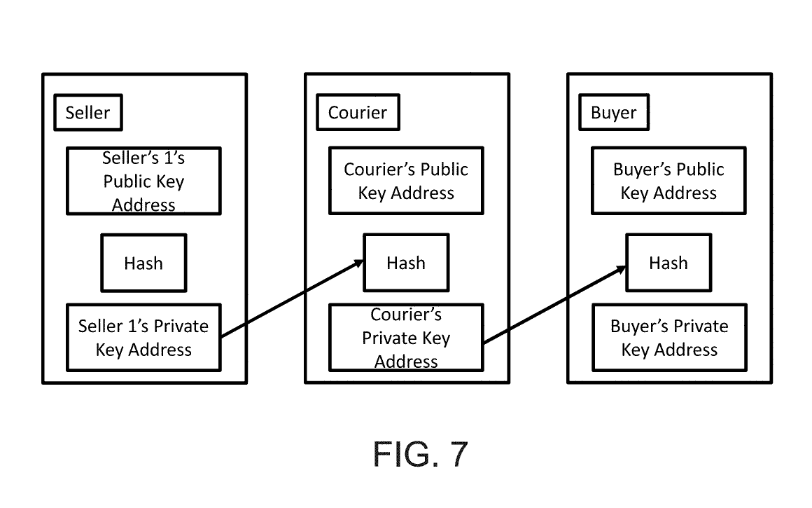

Referring further to the drawings, FIGS. 6-8 depict an embodiment of a block chain that may be incorporated with the smart package 10. The smart package 10, in addition to the component discussed above, may also include a delivery encryption system 80 comprising a block chain for package tracking and authentication as shown in FIG. 6. The block chain is ongoing chain hashed with key addresses along the chain of custody, including hashing with a seller private key address, a courier private key address and a buyer private key address as depicted in FIG. 7.

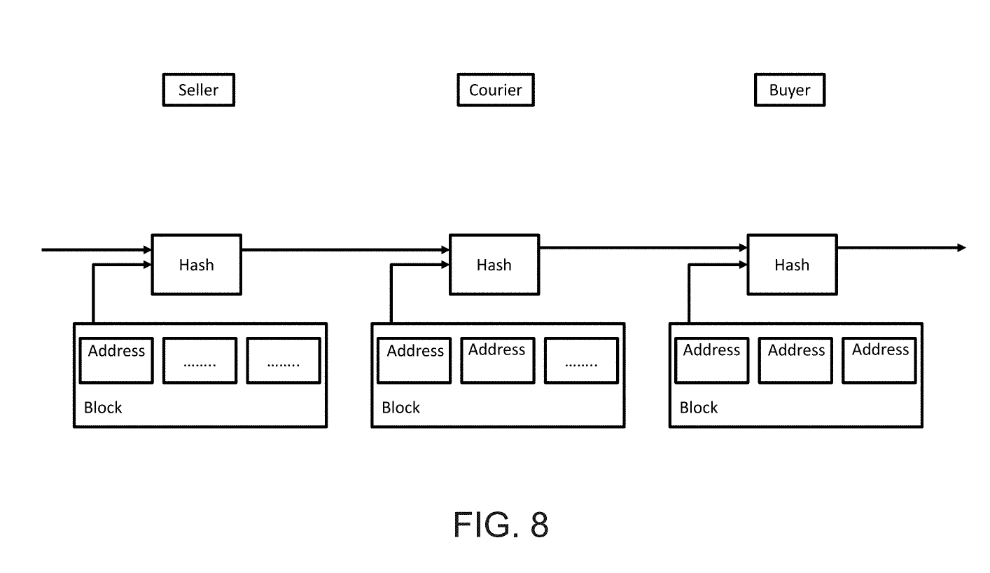

As depicted in FIGS. 7 and 8, the block chain registers a product 50 placed within the inner volume 40 of the smart package 10; registers the product 50 within the inner volume 40 as the smart package 10 moves through a supply chain; and authenticates a product 50 placed within the smart package 10 as the smart package 10 moves through a supply chain.

In embodiments, the block chain associated with a product 50 placed in the smart package 10 dynamically adjusts to account for the cold chain status of the product 50 as the smart package 10 moves through a supply chain. Further, in embodiments, the smart package 10 may include a plurality of products 50 placed within the inner volume 40 of the smart package 10, wherein the chain block of the delivery encryption system 80 tracks and authenticates each of the plurality of products 50 within the smart package 10.

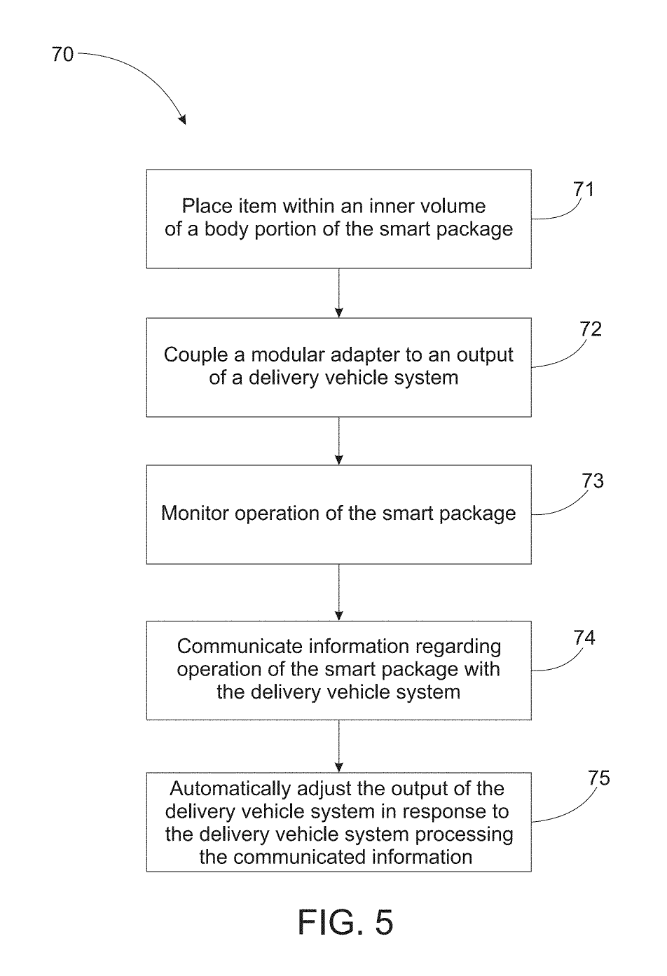

FIG. 5 is a flow diagram illustrating a method 70 for using a smart package, in accordance with some embodiments. While shopping online, a customer may select products for purchase and the items or products 50. At that point method 70 may be deployed, wherein the method 70 includes placing an item within an inner volume of a body portion of the smart package (Step 71); coupling a modular adapter to an output of a delivery vehicle system (Step 72); monitoring operation of the smart package (Step 73); communicating information regarding operation of the smart package with the delivery vehicle system (Step 74); and automatically adjusting the output of the delivery vehicle system in response to the delivery vehicle system processing the communicated information (Step 75).

The method 70 may include controlling access to the inner volume of the body portion of the smart package. Additionally, automatically adjusting the output of the delivery vehicle system may include deploying environmental control agents to maintain predetermined environment conditions.

As will be appreciated by one skilled in the art, aspects or components of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A smart package comprising:
a body portion having an inner volume;
a door coupled to the body portion, wherein the door is moveable between a closed and an open position, wherein in the closed position the door restricts access to the inner volume of the body portion and in the open position, an opening to the inner volume is exposed for access to the inner volume;
a monitoring device, wherein the monitoring device controls and monitors operation of the smart package; and
a modular adapter coupled to an outer surface of the body portion, wherein the modular adapter is configured to releasably connect to an output of a delivery vehicle system.

2. The smart package of claim 1, wherein the modular adapter is coupled to one of an air conditioning unit output, a temperature regulator output, a humidity regulator output, a power source output and a security panel output of the delivery vehicle system.

3. The smart package of claim 1, wherein the modular adapter is at least two modular adapters.

4. The smart package of claim 3, wherein the at least two modular adapters are each coupled to one of an air conditioning unit output, a temperature regulator output, a humidity regulator output, a power source output and a security panel output of the autonomous vehicle system, wherein each modular adapter is coupled to a different output of the delivery vehicle system.

5. The smart package of claim 1, wherein the monitoring device monitors environmental conditions and status of contents within the body portion.

6. The smart package of claim 5, wherein the monitoring device monitors and controls a power source of the smart package.

7. The smart package of claim 6, wherein the monitoring device monitors a location of the smart package.

8. The smart package of claim 7, wherein the monitoring device controls access to the inner volume of the body portion.

9. The smart package of claim 8, wherein the monitoring device monitors content insertion and content removal into and out of the inner volume of the body portion.

10. The smart package of claim 9, wherein the monitoring device monitors connection and disconnection of the smart package modular adapter with an output of the delivery vehicle system.

11. The smart package of claim 10, wherein the monitoring device is communicatively coupled to the delivery vehicle system and a central computing system and communicates information determined from the monitoring device regarding the smart package and the contents therein.

12. The smart package of claim 11, wherein the delivery vehicle system adjusts outputs in response to processing the information communicated from the monitoring device.

13. The smart package of claim 1, wherein the delivery vehicle system is an autonomous vehicle system

14. A method of using a smart package, the method comprising:
placing an item within an inner volume of a body portion of the smart package;
coupling a modular adapter to an output of a delivery vehicle system;
monitoring operation of the smart package;
communicating information regarding operation of the smart package with the delivery vehicle system; and
automatically adjusting the output of the delivery vehicle system in response to the delivery vehicle system processing the communicated information.

15. The method of claim 14, further comprising controlling access to the inner volume of the body portion of the smart package.

16. The method of claim 14, wherein automatically adjusting the output of the delivery vehicle system comprises deploying environmental control agents to maintain predetermined environment conditions.

17. The method of claim 14, wherein the delivery vehicle system is an autonomous vehicle system.

18. A smart package comprising:
a body portion having an inner volume;
a door coupled to the body portion, wherein the door is moveable between a closed and an open position, wherein in the closed position the door restricts access to the inner volume of the body portion and in the open position, an opening to the inner volume is exposed for access to the inner volume;
a modular adapter coupled to an outer surface of the body portion, wherein the modular adapter is configured to releasably connect to an output of a delivery vehicle system; and
a delivery encryption system comprising a block chain for package tracking and authentication.

19. The smart package of claim 18, wherein the block chain is ongoing chain hashed with key addresses along the chain of custody, including hashing with a seller private key address, a courier private key address and a buyer private key address.

20. The smart package of claim 18, wherein the block chain registers a product placed within the inner volume of the smart package.

21. The smart package of claim 20, wherein the block chain registers the product within the inner volume as the smart package moves through a supply chain.

22. The smart package of claim 18, wherein the block chain authenticates a product placed within the smart package as the smart package moves through a supply chain.

23. The smart package of claim 18, wherein the block chain associated with a product placed in the smart package dynamically adjusts to account for the cold chain status of the product as the smart package moves through a supply chain.

24. The smart package of claim 18, further comprising a plurality of products placed within the inner volume of the smart package, wherein the chain block of the delivery encryption system tracks and authenticates each of the plurality of products within the smart package.
